(19) United States
(12) Patent Application Publication
(10) Pub. No.: US 2006/0008725 A1
(43) Pub. Date: Jan. 12, 2006

(54) Microtoner formulation with enhanced classification properties and method of producing same

(75) Inventors: Mark J. Stachowski, Rochester, NY (US); David P. Nikodem, Pittsford, NY (US)

Correspondence Address: Mark G. Bocchetti;Patent Legal Staff, Eastman Kodak Company, 343 State Street, Rochester, NY, 14650-2201, US

(73) Assignee: Eastman Kodak Company

(21) Appl. No.: 10/888,059

(22) Filed: Jul. 9, 2004

(51) Int. Cl. G03G 9/087

(52) U.S. Cl. 430/108.11; 430/109.3; 430/109.4; 430/109.5; 430/108.1; 430/108.6; 430/137.2

(57) ABSTRACT

A method (10) for forming a microtoner (C) for use in the development of electrophotographic images includes blending at least one polymer (P₁, P₂, P₃, . . . P_{N}) with at least one thermoplastic polymer (P₁, P₂, P₃, . . . P_{N}) and with one or more pigments to thereby form a dry mix toner formulation (D). The dry mix toner formulation (D) is melt mixed to thereby form a melt mix toner formulation (M) which is pulverized into an unclassified intermediate toner mix (U). At least one surface treatment addenda material (X) is dry blended with the unclassified intermediate toner mix (U) to thereby produce a surface treated unclassified toner mix (S), which is then classified to produce a surface treated classified microtoner formulation (C) having an improved particle size distribution.

### FIELD OF THE INVENTION

The present invention relates generally to toner for use in electrophotographic processes and/or printing machines. More particularly, the present invention relates to a microtoner formulation having enhanced classification properties, and to a method for producing such a microtoner formulation.

### BACKGROUND OF THE INVENTION

The toner used in electrophotographic printing machines is a blend of materials, including plastic binder resins, coloring pigments, magnetic iron oxides, waxes, charge control agents and other additives and ingredients. Most toners are produced in bulk using a melt mixing or hot compounding process. The plastic binder resins, coloring pigments and other ingredients are blended together while in a molten state to thereby form a hot paste having a consistency similar to cake mix. This mixture is then cooled, typically by forming it into slabs on a cooling belt or by pelletizing the mixture and cooling the pellets.

It is desirable for a toner powder to have a small volume-median particle size and a relatively tight distribution of particle sizes around that small volume-median particle size. A toner having such qualities results in improved image quality, and is especially important in color electrophotographic processes. Therefore, the particle size of the palletized/cooled toner mixture is reduced using either of a primarily chemical or a primarily mechanical particle size reduction method.

Chemical particle size reduction methods are capable of producing the desired small volume-median particle sizes and desirably-narrow particle size distributions. However, the chemical methods require the purchase, storage, handling and disposal of chemicals that may be hazardous or toxic. Further, the chemical methods must be closely controlled and monitored, and are not as environmentally friendly as the mechanical methods.

Mechanical particle size reduction methods, such as, for example, grinding, milling or pulverizing, tend to produce toner particles having a particle size distribution that is undesirably wider than the particle size distribution produced by a chemical method. More particularly, as desired volume-median particle sizes approach 4 to 5 microns (μ), mechanically-reduced toners have a particle size distribution that contains a substantial number of particles at the very fine and super fine end of the distribution, i.e., particle sizes of less than approximately 2 microns. Such fine and super fine particles are not particularly well-suited for use in an electrophotographic process, and are difficult to handle, convey, process and contain. Therefore, the fine and super fine (as well as over-sized) particles are removed from the toner powder by a process referred to as classification. Classification of toner having a substantial number of fine and super fine particles is difficult, often requires multiple classification processes, and thus can be a time-consuming and inefficient process.

Therefore, what is needed in the art is a toner formulation from which fine and super fine particles are mechanically removed or classified with relative efficiency.

Furthermore, what is needed in the art is a method of producing a toner, other powder, or particulate material from which fine and super fine particles are mechanically removed or classified with relative efficiency.

### SUMMARY OF THE INVENTION

The present invention provides a microtoner and method for use in electrophotographically producing and/or reproducing images, and a method for producing such a toner.

The invention includes, in one form thereof, a method (10) for forming a microtoner (C) includes blending at least one thermoplastic polymer (P₁) with at least one other polymer (P₂, P₃, . . . P_{N}) and with one or more pigments to thereby form a dry mix toner formulation (D). The dry mix toner formulation (D) is melt blended to thereby form a melt mix toner formulation (M) which is extruded and pulverized into an unclassified intermediate toner mix (U). At least one surface treatment addenda material (X) is dry blended with the unclassified intermediate toner mix (U) to thereby produce a surface treated unclassified toner mix (S), which is then classified to produce a surface treated classified microtoner formulation (C) having an improved particle size distribution.

An advantage of the present invention is that the toner produced has a significantly reduced number of fine and super fine particles and can therefore be classified more efficiently.

### BRIEF DESCRIPTION OF THE DRAWINGS

The above-mentioned and other features and advantages of this invention, and the manner of attaining them, will become apparent and be better understood by reference to the following description of one embodiment of the invention in conjunction with the accompanying drawings, wherein:

FIG. 1 illustrates one embodiment of a method of the present invention for producing a microtoner for use in electrophotographically producing and/or reproducing images;

FIG. 2 illustrates one embodiment of an apparatus for producing a microtoner for use in electrophotographically producing and/or reproducing images;

FIG. 3 is a plot of the particle size volume distribution of the conventional microtoners of Conventional Examples 1 and 2 and the microtoner of Inventive Example 1; and

FIG. 4 is a plot of the particle size number distribution of the conventional microtoners of Conventional Examples 1 and 2 and the microtoner of Inventive Example 1.

Corresponding reference characters indicate corresponding parts throughout the several views. The exemplifications set out herein illustrate one preferred embodiment of the invention, in one form, and such exemplifications are not to be construed as limiting the scope of the invention in any manner.

### DETAILED DESCRIPTION OF THE DRAWINGS

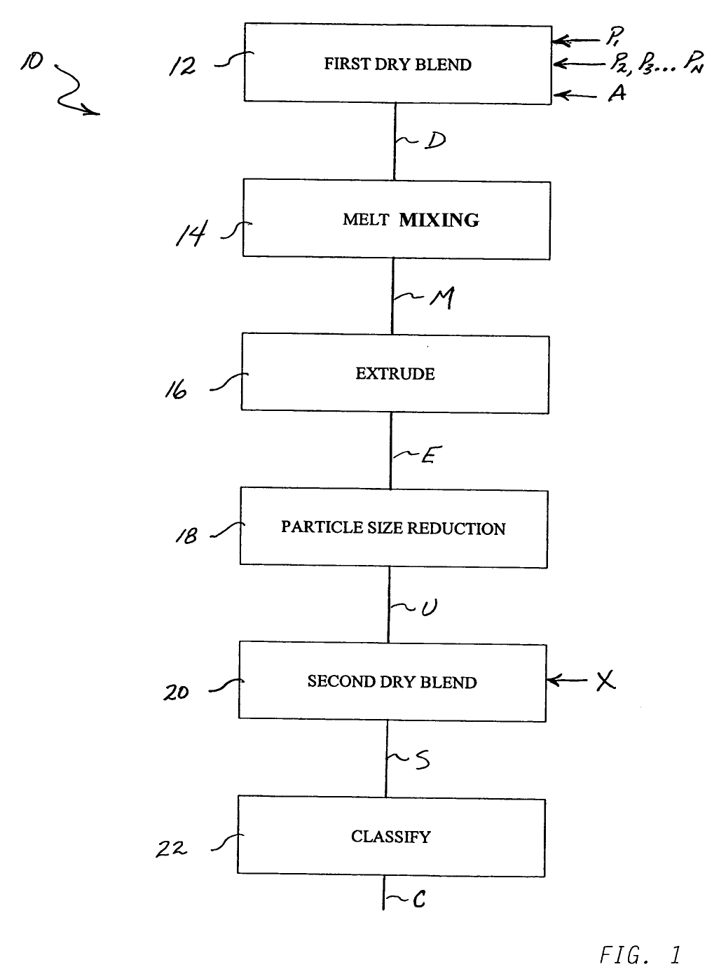

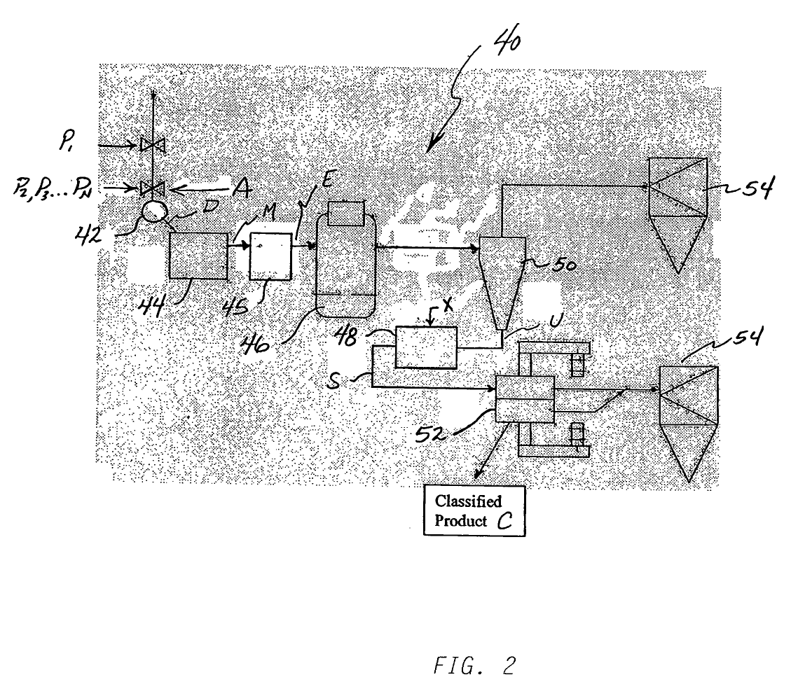

Referring now to the drawings, and particularly to FIGS. 1 and 2, there is respectively shown one embodiment of a method and one embodiment of an apparatus for producing a toner of the present invention. Method 10 (FIG. 1) includes the processes of dry blending 12, melt mixing 14, extruding 16, particle size reduction 18, second dry blending 20, and classifying 22. Apparatus 40 (FIG. 2) includes dry blender 42, melt mixer 44, particle size reduction device 46, dry blender 48, cyclone 50 and classifier 52.

Dry blending process 12 includes the blending together of a thermoplastic polymer binder resin P₁ with one or more polymer binder resins P₂, P₃, . . . P_{N}, which may or may not be thermoplastic binder resins, and with other ingredients and additives generally designated A that are conventionally used in toner, such as, for example, colorants, charge control agents, waxes, and other additives to produce a dry blend toner formulation or dry mix D. The polymer binders P₁ and P₂, P₃, . . . and P_{N} and the other ingredients/additives A are mixed or blended together using a dry mixer/blender 42 (FIG. 2), such as, for example, a high-speed blender manufactured by Henschel Industrietechnik GmbH.

Polymer binder resins P₁ and P₂, P₃, . . . and P_{N} include polyesters, polyamides, polyolefins, acrylic polymers and copolymers, methacrylic polymers and copolymers, styrenic polymers and copolymers, vinyl polymers and copolymers, and polyurethanes, and can be chemically the same or different from each other, so long as at least one of the binder resins is a thermoplastic binder resin. If two or more polymer binder resins that are chemically the same are used in producing dry mix D, the physical composition of the polymers must have a difference, such as, for example, different molecular weight distributions.

Dry mix toner formulation D is approximately 1 to approximately 30 percent by weight of one or more colorants, and approximately 70 to approximately 99 percent by weight of the combined polymer binder resins P₁ and P₂, P₃, . . . and P_{N}. Preferably, dry mix D is approximately 4 to approximately 20 percent by weight of one or more colorants, and approximately 80 to approximately 96 percent by weight of combined polymer binder resins P₁ and P₂, P₃, . . . and P_{N}. Most preferably, dry mix D is approximately 6 to approximately 10 percent by weight of one or more colorants, and approximately 90 to approximately 94 percent by weight of combined polymer binder resins P₁ and P₂, P₃, . . . and P_{N}. Dry mix D may also include ingredients, such as, for example, a charge agent, release agent, or other additives that are blended together with the polymer(s) during the formation of dry mix D.

Melt mixing process 14 is carried out by processing blended-polymer dry mix D through a conventional melt mixing apparatus 44, such as, for example, an extruder, roll mill or kneading mill, at conventional melt mixing temperatures of approximately 60° C. to approximately 160° C. and preferably approximately 100° C. Thereafter, extruding process 16 is similarly carried out by a conventional extruding apparatus 45 using conventional extrusion methods/mechanisms, and thus an extruded melt mix M is formed. It should be understood that melt mixing apparatus 44 and extruding apparatus 45 are often combined into a single piece of machinery.

Particle size reduction process 18 is then conducted upon extruded melt mix M. Particle size reduction process 18 utilizes conventional particle size reduction apparatus 46, such as, for example, a jet mill, air mill, pulverizer, or grinder, and conventional particle size reduction process parameters to reduce the particle size of extruded melt mix M. For example, particle size reduction apparatus 46 is accomplished by processing extruded melt mix M with a jet mill pulverizer operating with a pressure of less than 200 pounds per square inch (psi.) and preferably below approximately 115 psi. Raw and unclassified intermediate toner U produced by particle size reduction process 18 is then provided to second dry blending process 20.

Second dry blending process 20 mixes or blends together unclassified intermediate toner U with one or more surface treatment addenda X to produce surface-treated unclassified toner S. Dry blending process 20, in a substantially similar manner as dry blending process 12, is carried out using dry blender 48 (FIG. 2), such as, for example, a high-speed blender manufactured by Henschel Industrietechnik GmbH.

The one or more surface treatment addenda X added to and blended with unclassified intermediate toner U by dry blending process 20 include particles or nanoparticles that when present in the toner formulation are believed to decrease the van der Waals forces of attraction that exist between powders. Examples of such particles include particles of inorganic oxides, metals, polymers or combinations thereof, including fumed silica, fumed titania, zinc oxide, styrene acrylics, polymethylmethacrylates, polyvinylidenefluoride, polytetrafluoro-ethylene, silicones, polyolefins, and other suitable particles. Preferably, the surface treatment addenda X include microparticulates and/or nanoparticulates having an average particle size less than approximately 1.0μ. More preferably, the surface treatment addenda X include microparticulates and/or nanoparticulates having an average particle size less than approximately 0.1μ, and most preferably with an average particle size less than approximately 0.01μ.

Classifying process 22 is then conducted using a conventional cyclone apparatus 50 and/or classifying apparatus 52 as required or preferred. Many of the undesirably fine and/or super-fine particles contained within surface-treated unclassified toner U are carried by a pressurized flow of air or gas from cyclone 50 into a first dust collector 54. Classifier 52 receives the surface-treated unclassified toner S from cyclone 50, sorts or classifies the surface-treated unclassified toner S based on particle size, and delivers classified toner powder C having a desired volume median average particle sizes and a desired particle size distribution to other downstream processing equipment, such as, for example, a bulk container or bulk container-filling apparatus (neither of which are shown). Many of the fine and super fine particles within classifier 52 are removed therefrom and captured within a second cyclone and/or vacuum dust collector 54.

As the following Examples illustrate with specificity, classified toner powder C of has a reduced volume-median particle size and contains significantly fewer fine and super fine particles relative to toner produced from a conventional formulation and process. Since the classified toner powder C of the present invention has an improved particle size distribution, the need for multiple classification processes is reduced and the efficiency of the classification process is increased. Therefore, production of the toner of the present invention is less costly.

### CONVENTIONAL EXAMPLE 1

A conventional toner extrudate was prepared by melt blending in a 30 millimeter (mm) twin-screw extruder Regal 330 carbon black pigment, obtained from Cabot Corporation, Billerica, Mass., USA, with Binder C polyester, obtained from Kao Corporation of Tokyo, Japan, and with 2 parts per hundred (pph) Bontron E-84 charge agent such that the final pigment concentration was 4.5 parts of pigment per 100 parts resin by weight. The pigment concentration was chosen for specific colorimetric properties not pertinent to the invention. The toner extrudate was cooled out of the extruder using a chill-belt and granulated in a Wiley-type mill into granules of approximately 500 microns in size.

The above-described granulated black toner extrudate was then pulverized using a Hosokawa-Alpine 200 AFG jet mill pulverizer at a nozzle pressure of approximately 80 pounds per square inch and an average rotor speed of approximately 11,500 revolutions per minute to produce an unclassified toner, and a bed level indicated by a rotor current of approximately 2.6 Amps (A).

The unclassified toner had a volume-median particle size of approximately 5.26 microns and a number-median particle size of approximately 3.44 microns as measured on a Coulter Mutlisizer with a 70μ aperture. Thus, a particle size dispersity index (PSDI), which is the ratio of the volume-median particle size to the number-median particle size, of approximately 1.53 was obtained. The particle size measurements were conducted using a Coulter Multisizer 11 with a 70μ aperture.

The pulverized toner was further size classified at the fine end using a Hosokawa-Alpine 100 ATP classifier with a rotor speed of approximately 18,160 revolutions per minute and a blower setting of approximately 100%. The coarse, or product, cut from this condition yielded a particle size distribution with a 5.45μ volume-median particle size, 4.66μ number-median particle size and thus a particle size dispersity index of approximately 1.17, as measured on a Coulter Multisizer with a 30μ aperture.

It is to be understood that the model number of the mill is specific to the size of the mill, and is independent of the experimental data presented herein.

It is also to be understood that the particle size dispersity index as referred to herein is defined as the ratio of the volume-median particle size to the number-median particle size, and is indicative of the number or proportion of fine particles within the toner formulation at any given/specified point within the process, since both medians are a function of the total distribution.

### CONVENTIONAL EXAMPLE 2

A second conventional single-polymer toner extrudate was prepared by melt blending in a 30 mm twin-screw extruder Regal 330 carbon black pigment, obtained from Cabot Corporation, Billerica, Mass. USA, with Binder W-85 polyester, obtained from Kao Corporation of Tokyo, Japan, and with 2 pph Bontron E-84 charge agent such that the final pigment concentration was 6.0 parts of pigment per 100 parts resin by weight. The pigment concentration was chosen for specific calorimetric properties not pertinent to the invention. The toner extrudate was cooled out of the extruder through a chill-belt and granulated in a Wiley-type mill into granules of approximately 500 microns in size.

The above-described granulated black toner extrudate was then pulverized using a Hosokawa-Alpine 200 AFG jet mill pulverizer at a nozzle pressure of approximately 80 psi with an average rotor speed of approximately 10,500 revolutions per minute, and a bed level indicated by a rotor current of 3.2 A. An unclassified toner was produced having a volume-median particle size of approximately 3.77 microns (μ) and a 2.46μ number-median particle size as measured on a Coulter Multisizer with a 30μ aperture. Thus, a particle size dispersity index of approximately 1.53 was also obtained.

The unclassified toner was then classified using a classifier, such as, for example, a Hosokawa-Alpine 100ATP classifier with a rotor speed of approximately 17,900 revolutions per minute (rpm) and the blower at full capacity (100%). This first classification process produced a toner having a volume-median particle size of approximately 4.00μ and a 3.30μ number-median particle size as measured on a Coulter Multisizer with a 70μ aperture. Thus, a particle size dispersity index of approximately 1.21 was obtained. The classified toner was then again passed through the classifying process, i.e., a second classifying process using the above-described classifier at a rotor speed of approximately 15,600 rpms with the blower at full capacity.

The toner produced by the second classifying operation/process had a volume-median particle size particle size of approximately 3.94μ and approximately 3.37 number-median particle size as measured on a Coulter Multisizer with a 70μ aperture. Thus, a particle size dispersity index of approximately 1.17 was obtained. The particle size measurements were repeated and generally corroborated using a Coulter Multisizer with a 30μ aperture which instrument produced data indicating a volume-median particle size of approximately 4.56μ and approximately 3.63 number-median particle size and thereby indicated a particle size dispersity index of approximately 1.26.

Thus, two classification steps were required to reduce the particle size dispersity index of the conventional toner of conventional examples 1 and 2 from approximately 1.53 in the unclassified state to approximately 1.26-1.17 in the classified state.

### INVENTIVE EXAMPLE 1

In contrast to the above examples, the toner formulation produced by the method of the present invention has an increased classification efficiency, i.e., the toner is more efficiently classified to remove fine and super fine particles therefrom. More particularly, the toner formulation of the present invention adds surface treatment addenda X to an unclassified toner mix U by a second dry mixing process to thereby produce an unclassified toner S that, when processed by conventional classification methods and/or processes, produces a classified toner C having a significantly smaller amount of fine and super-fine particles and, thus, an improved particle size distribution.

More particularly, melt mix M was prepared by melt blending in a 30 mm twin-screw extruder Regal 330 carbon black pigment, obtained from Cabot Corporation, Billerica, Mass., USA, with 2 pph Bontron E-84 charge agent, and with a blend of two polyesters. The polyesters in this exemplary embodiment were Binder C and binder W-85, both of which were obtained from Kao Corporation of Tokyo, Japan. The ratio of the two polyesters was 20 percent to 80 percent of the total resin, and the final pigment concentration was 6.0 parts of pigment per 100 parts resin by weight. The pigment concentration was chosen for specific calorimetric properties not pertinent to the invention. The melt mix M was cooled out of the extruder through a chill-belt, and granulated in a Wiley-type mill into granules of approximately 500 micron in size to produce extrudate E.

The above-described extrudate E was then pulverized on a Hosokawa-Alpine 200 AFG jet mill pulverizer, using a nozzle pressure of approximately 80 psi, an average rotor speed of approximately 11,500 revolutions per minute, and a bed level indicted by the rotor current of 2.6 amps. An unclassified toner powder U was thereby produced having a volume-median particle size of approximately 3.72 microns and a 2.61 number-median particle size as measured on a Coulter Multisizer using a 30 micron aperture. Thus, a particle size dispersity index of 1.42 was obtained.

The unclassified toner powder U was then surface treated with fumed silica, identified as R972 and obtained from Degussa Corporation, at a level of approximately 2.0% by weight in a dry mixing operation carried out in a dry mixer, such as, for example, a Henschel FM-10 high-speed mixer at 2000 rpms for approximately twenty minutes, to produce a surface treated unclassified toner S. Adding the surface treatment to unclassified toner powder U increased the aerated bulk density from approximately 0.226 to approximately 0.279 grams/milliliter, measured using a Hosokawa Micron Powder Tester, and facilitated the bulk feeding of surface treated unclassified toner S into a classifier.

The surface-treated unclassified toner S was then processed through a single classifying operation using a Hosokawa-Alpine 50ATP classifier at a rotor speed of approximately 21,500 revolutions per minute (rpm) and full blower capacity (100%). A classified toner powder C was thereby produced having a volume-median particle size of approximately 4.27μ and a 4.01μ number-median particle size as measured on a Coulter Multisizer using a 30μ aperture. Thus, a particle size dispersity index of 1.06 was obtained. The 30μ aperture is more efficient than a larger aperture at detecting particles in the 0.75 to 1.35μ particle size range and thereby increases the measurement/detection resolution for particles in that size range and empirically demonstrates the reduction in fine and super fine particles in the classified surface treated toner C.

### Discussion

Generally, the above examples demonstrate that surface treating an unclassified but pulverized toner (i.e., surface treated unclassified toner S) prior to classification thereof produces a classified toner powder C having a desired final median particle size and an improved (i.e., tighter) particle size distribution that desirably contains significantly fewer fine and super fine particles relative to conventional non-surface treated pulverized toner. Therefore, the classification process of the toner produced by the method of the present invention is significantly more efficient and less technologically challenging.

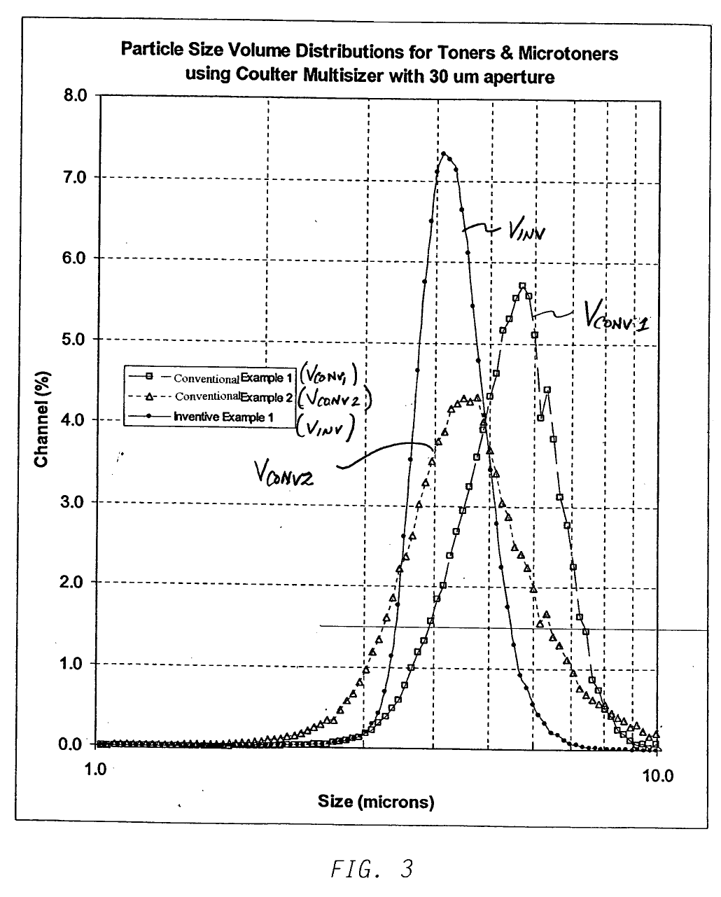

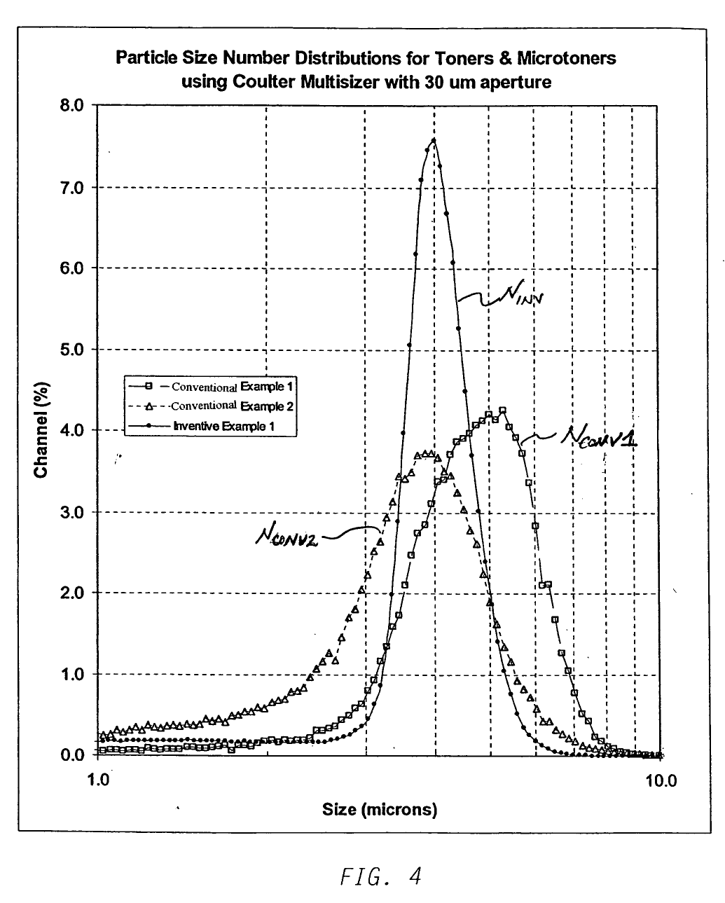

The above-described improvements are graphically illustrated by FIGS. 3-4. In FIGS. 3 and 4, the volume and number particle size distributions, respectively, are plotted for the surface-treated classified toner C of Inventive Example 1 and the non-surface treated and classified toners of Conventional Examples 1 and 2. More particularly, with reference to FIG. 3, curve V_{INV} shows the particle size volume distribution for the classified toner powder of Inventive Example 1, curve V_{CONV1} shows the particle size volume distribution for the classified toner powder of Conventional Example 1, and curve V_{CONV2} shows the particle size volume distribution for the classified toner powder of Conventional Example 2. Similarly, as shown in FIG. 4, curve N_{INV} shows the particle size number distribution for the classified toner powder of Inventive Example 1, curve N_{CONV1} shows the particle size number distribution for the classified toner powder of Conventional Example 1, and curve N_{CONV2} shows the particle size number distribution for the classified toner powder of Conventional Example 2.

As shown in FIG. 4, for particle size values of less than approximately two microns the particle size number distribution curve N_{INV} for the classified toner of the present invention (i.e., of inventive example 1) lies well below the particle size number distribution curves N_{CONV1} of the conventional toner of Conventional Example 1 and the particle size number distribution curve N_{CONV2} of the conventional toner of Conventional Example 2. Since the area under each of the curves indicates the number of particles of a given size contained within the corresponding toner, and since for particle sizes of less than approximately 2μ the area under curve N_{INV} is substantially less than the area under curves N_{CONV1} and N_{CONV2}, FIG. 4 graphically shows that the toner of inventive Example 1 has a substantially reduced number of particles of 2μ or less in size relative to the conventional toners of Conventional Examples 1 and 2. The substantial reduction in the number of particles of 2μ or less in the toner of the present invention is also shown in Table 1 below:

TABLE 1

| | Volume Median | Number Median | |
|---|---|---|---|
| | Particle Size | Particle Size | |
| Toner | (μ) | (μ) | PSDI |
| Conventional Example 1: | 5.26 | 3.44 | 1.53 |
| (Unclassified *) | | | |
| Conventional Example 1: | 5.45 | 4.66 | 1.17 |
| (Classified **) | | | |
| Conventional Example 2: | 3.77 | 2.46 | 1.53 |
| (Unclassified *) | | | |
| Conventional Example 2: | 4.00 | 3.30 | 1.21 |
| (First Classification *) | | | |
| Conventional Example 2: | 3.94 | 3.37 | 1.17 |
| (Second Classification *) | | | |
| Conventional Example 2: | 4.56 | 3.63 | 1.26 |
| (Second Classification **) | | | |
| Inventive Example 1: | 3.72 | 2.61 | 1.42 |
| (Unclassified **) | | | |
| Inventive Example 1: | 4.27 | 4.01 | 1.06 |
| (First Classification **) | | | |

* using Coulter Multisizer with 70 micron aperture
** using Coulter Multisizer with 30 micron aperture

As shown above, the toner of the present invention has a PSDI that is much tighter, i.e., contains fewer fine and super fine particles, than the toner of the conventional examples. Of particular interest is the toner of Conventional Example 2, wherein two classification processes are required to reduce the PSDI from 1.53 in the unclassified condition to 1.17 following the second classification operation. Two classification operations were required to reduce the PSDI of the conventional toner of Conventional Example 2 by approximately 24 percent. Conversely, the PSDI of the toner of the present invention is reduced from 1.42 to 1.06 by a single classification operation. Thus, a single classification operation achieves a reduction of 25 percent in the PSDI of the toner of the present invention. It should be noted that as the PSDI approaches 1.00, the toner particle size distribution is becoming desirably monodispersed.

As the date of Table 1 demonstrates in a summary form, the toner of the present invention is more efficiently and expediently classified than conventional toners, and has significantly fewer fine and/or super fine particles.

In summary, surface treating an unclassified but pulverized toner (i.e., surface treated unclassified toner S) prior to classification thereof produces a classified toner powder C having a desired final median particle size and an improved (i.e., tighter) particle size distribution that desirably contains significantly fewer fine and super fine particles relative to conventional non-surface treated pulverized toner. The toner of the present invention is therefore more readily and less expensively classified than conventional toners.

It should also be particularly noted that the flow of dry ink toner particles used in electrophotography is often measured using a flow apparatus, such as a Hosokawa Micron Powder Tester, where a given mass of flow is measured in a fixed volume yielding a powder density (such as in grams/millimeter-cubed). The powder density is also variously referred to as apparent density, aerated density, aerated bulk density, or other similar designations. Generally, the desirable value of a flow property of a given material, such as aerated density, is dependent upon and/or determined in light of the given purpose or function of the material. As the particle size of dry ink toner is reduced to enhance image quality, the powder flow values also generally decrease and thereby render the powder less flowable, more difficult to handle and more easily bound together. Reduced powder flow values make removal of the fine and super fine particles, i.e., classification of the powder at the fine ends of the distribution, that much more difficult and inefficient. Surface treatment of unclassified powders increases the aerated density and flowability thereof and thus improves the ability of the powder to be dispersed into an air stream, and thereby to be flowed into the classifier, be effectively classified, and as unexpectedly found, have improved classification efficiency with a narrow particle size distribution and/or improved yield.

In the embodiments shown, the process of producing the toner of the present invention dry blends with a dry-blend mixer the surface treatment addenda X into the unclassified intermediate toner U prior to the classification process. However, it is to be understood that the process of the present invention can be alternately configured to add the surface treatment addenda X to the unclassified intermediate toner U via alternate means, such as, for example, by injection into the particulate stream.

While this invention has been described as having a preferred composition, the present invention can be further modified within the spirit and scope of this disclosure. This application is therefore intended to cover any variations, uses, or adaptations of the present invention using the general principles disclosed herein. Further, this application is intended to cover such departures from the present disclosure as come within the known or customary practice in the art to which this invention pertains and which fall within the limits of the appended claims.

### PARTS LIST

10 Method
12 First Dry Blending
14 Melt mixing
16 Extruding
18 Particle Size Reduction
20 Second Dry Blending
22 Classifying
40 Apparatus
42 First Dry Blender
44 Melt Mixer
46 Particle size reducing apparatus
48 Second Dry Blender
50 Cyclone
52 Classifier
54 Dust Collector
A—Additives
D—Dry Mix
P₁—Polymer Binder Resin
P₂, P₃, . . . P_{N}—Polymer Binder Resins
E—Extrudate
M—Melt Mix
U—Unclassified Intermediate Toner
S—Surface Treated Unclassified Toner
X—Surface Treatment Addenda
C—Classified Toner

What is claimed is:

1. An unclassified microtoner formulation, comprising:
a polymer blend including at least one polymer and at least one thermoplastic polymer; and
at least one surface treatment addenda.

2. The unclassified microtoner formulation of claim 1, wherein said polymer and said thermoplastic polymer are each individually selected from the group consisting essentially of polyesters, polyamides, polyolefins, acrylic polymers and copolymers, methacrylic polymers and copolymers, styrenic polymers and copolymers, vinyl polymers and copolymers, and polyurethanes.

3. The unclassified microtoner formulation of claim 2, wherein said surface treatment addenda comprise particles of a surface treatment material that decrease forces of attraction between powders.

4. The unclassified microtoner formulation of claim 3, wherein said surface treatment material includes inorganic oxides, metals, polymers and combinations thereof.

5. The unclassified microtoner formulation of claim 4, wherein said surface treatment material includes fumed silica, fumed titania, zinc oxide, styrene acrylics, polymethylmethacrylates, polyvinylidenefluoride, polytetrafluoroethylene, silicones, and polyolefins.

6. The unclassified microtoner formulation of claim 3, wherein said particles have an average particle size of approximately 1.0 micron or less.

7. The unclassified microtoner formulation of claim 3, wherein said particles have an average particle size of approximately 0.1 microns or less.

8. The unclassified microtoner formulation of claim 3, wherein said particles have an average particle size of approximately 0.01 microns or less.

9. The unclassified microtoner formulation of claim 3, further comprising one or more pigments, said pigments comprising from approximately one to approximately thirty percent by weight of said microtoner formulation, and said polymer blend comprises from approximately ninety-nine to approximately seventy percent by weight of said microtoner formulation.

10. The unclassified microtoner formulation of claim 3, wherein said one or more pigments comprise from approximately four to approximately twenty percent by weight of said microtoner formulation, and said polymer blend comprises from approximately ninety-six to approximately eighty percent by weight of said microtoner formulation.

11. The unclassified microtoner formulation of claim 3, wherein said one or more pigments comprise from approximately six to approximately ten percent by weight of said microtoner formulation, and said polymer blend comprises from approximately ninety-four to approximately ninety percent by weight of said microtoner formulation.

12. The unclassified microtoner formulation of claim 3, wherein each of said at least one polymer and said at least one thermoplastic polymer comprise thermoplastic polymers.

13. The unclassified microtoner formulation of claim 12, wherein said polymers are the same thermoplastic polymer but with different molecular weights.

14. The unclassified microtoner formulation of claim 3, wherein said polymers are different thermoplastic polymers.

15. A method of forming a microtoner for use in the development of electrophotographic images, comprising:
blending at least one polymer with at least one thermoplastic polymer and with one or more pigments to thereby form a dry mix toner formulation;
melt mixing the dry mix toner formulation to thereby form a melt mix toner formulation;
pulverizing the toner formulation into an unclassified intermediate toner mix;
dry blending at least one surface treatment addenda material with said unclassified intermediate toner mix to thereby produce a surface treated unclassified toner mix; and
classifying the surface treated unclassified microtoner formulation.

16. The microtoner formulation formed by the method of claim 15, wherein said polymer and said thermoplastic polymer are each individually selected from the group consisting essentially of polyesters, polyamides, polyolefins, acrylic polymers and copolymers, methacrylic polymers and copolymers, styrenic polymers and copolymers, vinyl polymers and copolymers, and polyurethanes.

17. The microtoner formulation formed by the method of claim 15, wherein said at least one surface treatment addenda comprises particles of a surface treatment material that decrease forces of attraction between powders.

18. The microtoner formulation formed by the method of claim 15, wherein said surface treatment material includes inorganic oxides, metals, polymers and combinations thereof.

19. The microtoner formulation formed by the method of claim 15, wherein said surface treatment material includes fumed silica, fumed titania, zinc oxide, styrene acrylics, polymethylmethacrylates, polyvinylidenefluoride, polytetrafluoroethylene, silicones, and polyolefins.

20. The method of forming a particulate microtoner of claim 15, wherein said blending step comprises dry blending.

21. The method of forming a microtoner of claim 15, wherein said pulverizing process is carried out by a conventional mechanical means with conventional process parameters.

22. The method of forming a microtoner of claim 21, wherein said conventional mechanical means of pulverizing comprises a jet mill pulverizer.

23. A method of improving the particle size distribution of a microtoner formulation, said method comprising adding at least one surface treatment addenda to a pulverized toner formulation prior to classifying said microtoner formulation.

24. The method of claim 23, wherein said adding process comprises dry blending or mixing each said at least one surface treatment addenda with the pulverized microtoner formulation.

25. The method of claim 23, wherein each said at least one treatment addenda comprises particles of a surface treatment material that decrease forces of attraction between powders.

26. The method of claim 25, wherein said surface treatment material includes inorganic oxides, metals, polymers and combinations thereof.

27. The method of claim 25, wherein said surface treatment material includes fumed silica, fumed titania, zinc oxide, styrene acrylics, polymethylmethacrylates, polyvinylidenefluoride, polytetrafluoroethylene, silicones, and polyolefins.

28. The method of claim 25, wherein said particles have an average particle size of approximately 1.0 micron or less.

29. The method of claim 25, wherein said particles have an average particle size of approximately 0.1 microns or less.

30. The method of claim 25, wherein said particles have an average particle size of approximately 0.01 microns or less.

31. A method of improving the classification efficiency of a microtoner formulation, said method comprising adding at least one surface treatment addenda to a pulverized toner formulation prior to classifying said microtoner formulation.

32. The method of claim 31, wherein said adding process comprises dry blending or mixing each said at least one surface treatment addenda with the pulverized microtoner formulation.

33. The method of claim 31, wherein each said at least one treatment addenda comprises particles of a surface treatment material that decrease forces of attraction between powders.

34. The microtoner formulation formed by the method of claim 33, wherein said surface treatment material includes inorganic oxides, metals, polymers and combinations thereof.

35. The microtoner formulation formed by the method of claim 33, wherein said surface treatment material includes fumed silica, fumed titania, zinc oxide, styrene acrylics, polymethylmethacrylates, polyvinylidenefluoride, polytetrafluoroethylene, silicones, and polyolefins.
